(19) United States
(12) Patent Application Publication
(10) Pub. No.: US 2003/0068904 A1
(43) Pub. Date: Apr. 10, 2003

(54) Electrician's gloves

(76) Inventor: Terrick R. Williams, Liberty Hill, TX (US)

Correspondence Address: BRACEWELL & PATTERSON, L.L.P., P.O. BOX 969, AUSTIN, TX, 78767-0969, US

(21) Appl. No.: 10/231,769

(22) Filed: Aug. 28, 2002

Related U.S. Application Data
(60) Provisional application No. 60/315,656, filed on Aug. 29, 2001.

(51) Int. Cl. H01R 33/00

(52) U.S. Cl. 439/37

(57) ABSTRACT

A glove to be worn when connecting power equipment to a multi-phase electrical panel is disclosed. On the back of the glove are indicia of the colors of wiring that are proper for connection to various row buses. The indicia are arranged in a manner analogous to a layout of the multi-phase electrical panel, thus providing a quick reference cue for which connection point should be used for a particular wire.

### RELATED PATENT APPLICATION

The present patent application claims priority to copending provisional application U.S. Serial No. 60/315,656, filed on Aug. 29, 2001.

### BACKGROUND OF THE INVENTION

1. Technical Field

In general, the present invention relates to an apparatus for assisting in the connection of electrical wiring to an electrical panel. In particular, the present invention relates to a pair of electrician's gloves having a quick reference for assisting an electrician in making electrical connections to an electrical panel.

2. Description of the Related Art

Three-phase power systems are utilized in nearly all industrial and commercial high-powered equipment because of their relatively higher efficiency over single-phase power systems. In the United States, there are two main topologies for connecting three-phase power systems, namely, a Delta power connection and a Wye power connection.

A Delta power connection (“Delta”) 100, as shown in FIG. 1a, is formed by connecting three independent transformers (or generators) in a loop without a neutral connection. Typically, each phase generates 120 volts of alternating current (V_{AC}). As there is no neutral connection in Delta 100, all power from Delta 100 is phase-to-phase, resulting in a minimum of 240 V_{AC}. For example, a first connection to a point 102 (Phase A) and a second connection to a point 104 (Phase B) provides a total voltage of 240 V_{AC}.

A Wye power connection (“Wye”) 110, as shown in FIG. 1b, is formed by connecting three independent transformers (or generators) to a common point known as a neutral connection. Two different voltage levels are available from Wye 110: a two-phase voltage and a single-phase voltage. In order to obtain a two-phase voltage from Wye 110, connections are made between two phases in a manner similar to that described above for Delta 100. For example, a first connection can be made at a point 112 (Phase A) and a second connection can be made at a point 114 (Phase B) in order to provide a total voltage of 208 V_{AC}. The voltage of 208 V_{AC} (instead of 240 V_{AC}) is caused by the unique power phase relationship found in a Wye power connection. In order to obtain a single-phase voltage from Wye 110, a first connection is made at one of the voltage phases and a second connection is made at the neutral connection. For example, a first connection made at point 112 and a second connection made at a neutral point 116 provides a total voltage of 120 V_{AC}.

Connections can be made from Delta 100 or Wye 110 to a bus in a breaker panel (also called a junction box or fuse panel). Typically, the connection is made in a manner shown in FIG. 2. As shown, a panel 200 has many row buses 202, each of row buses 202 having a connection point at each end. For example, a row bus 202a has a connection point 1 at one end and a connection point 2 at the other end. In this example, row bus 202a is connected to Phase A of Wye 110 (from FIG. 1b). Thus, connecting a wire to connection point 1 or 2 provides an electrical contact with Phase A in Wye 110. Row bus 202b is connected to Phase B of Wye 110, and row bus 202c is connected to Phase C of Wye 110. Continuing down the panel, row bus 202d is connected to Phase A of Wye 110, row bus 202e is connected to Phase B of Wye 110, row bus 202f is connected to Phase C of Wye 110, etc.

Section 210-5 of the National Electrical Code mandates color coding for wiring of equipment using three-phase power. For example, the wiring for a 120/208 V_{AC} Wye electrical system must comply with the following color coding: PHASE A-Black; PHASE B-Red; PHASE C-Blue; NEUTRAL-White. Thus, as illustrated in FIG. 2, a black wire 210 is utilized to connect a Phase A connection point 209 of an electrical equipment 208 to row bus 202a (Phase A) of panel 200, a red wire 212 is utilized to connect a Phase B connection point 211 of electrical equipment 208 to row bus 202b (Phase B) of panel 200, a blue wire 214 is utilized to connect a Phase C connection point 213 of electrical equipment 208 to row bus 202c (Phase C) of panel 200, and a white wire 216 is utilized to connect a neutral connection point 215 of electrical equipment 208 to a neutral bus 220 of panel 200.

When connecting color coded wires, such as wires 210, 212, 214 and 216, to panel 200, an electrician must be able to know which one of row buses 202 is at which power phase. Improperly connecting a wire to the wrong phase may result in serious damage to a piece of equipment and/or injury to the electrician or an operator of the equipment. Some electricians may rely on a mnemonic device to remember which one of row buses 202 is associated to which phase of power. But in a hot, noisy and stressful environment, an electrician may not be able concentrate when confronted with more than a hundred of wires. Consequently, there is a need for an apparatus to assist an electrician to determine which row bus in a breaker panel is associated with which phase of power in a multi-phase power environment.

### SUMMARY OF THE INVENTION

In accordance with a preferred embodiment of the present invention, a glove is worn by an electrician when connecting an electrical equipment to a multi-phase electrical breaker panel. On the back of the glove is an indicia of the color wiring that is proper for connection to a particular row bus having number connection point ends. The indicia can be arranged in a manner analogous to a layout of the multi-phase electrical panel, thus providing a quick visual cue for which connection point should be used for a particular wire.

All objects, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1a is a schematic illustration of a Delta connected power source;

FIG. 1b is a schematic illustration of a Wye connected power source;

FIG. 2 depicts a typical electrical breaker panel for connecting a Wye power source to an electrical equipment;

FIG. 3 depicts a pair of electrician's gloves in accordance with a preferred embodiment of the present invention; and

FIG. 4 depicts a pair of electrician's gloves in accordance with an alternative embodiment of the present invention.

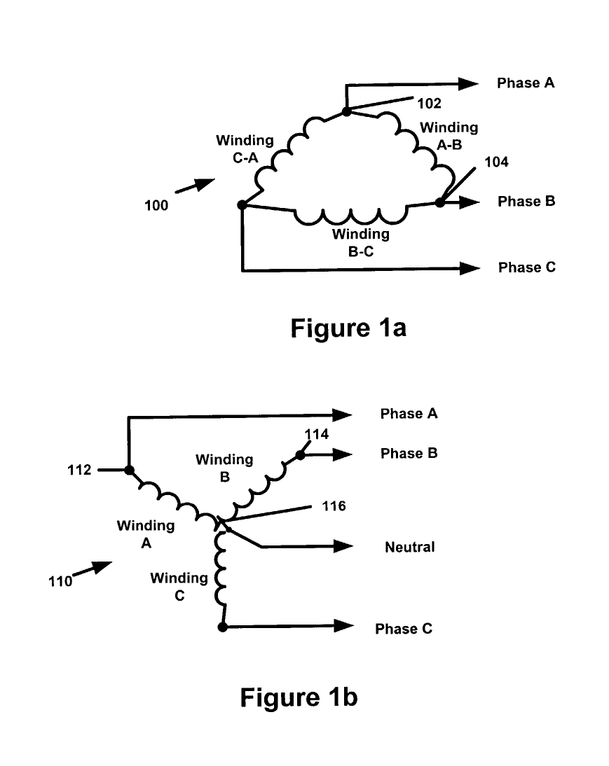

### DETAILED DESCRIPTION OF A PREFERRED EMBODIMENT

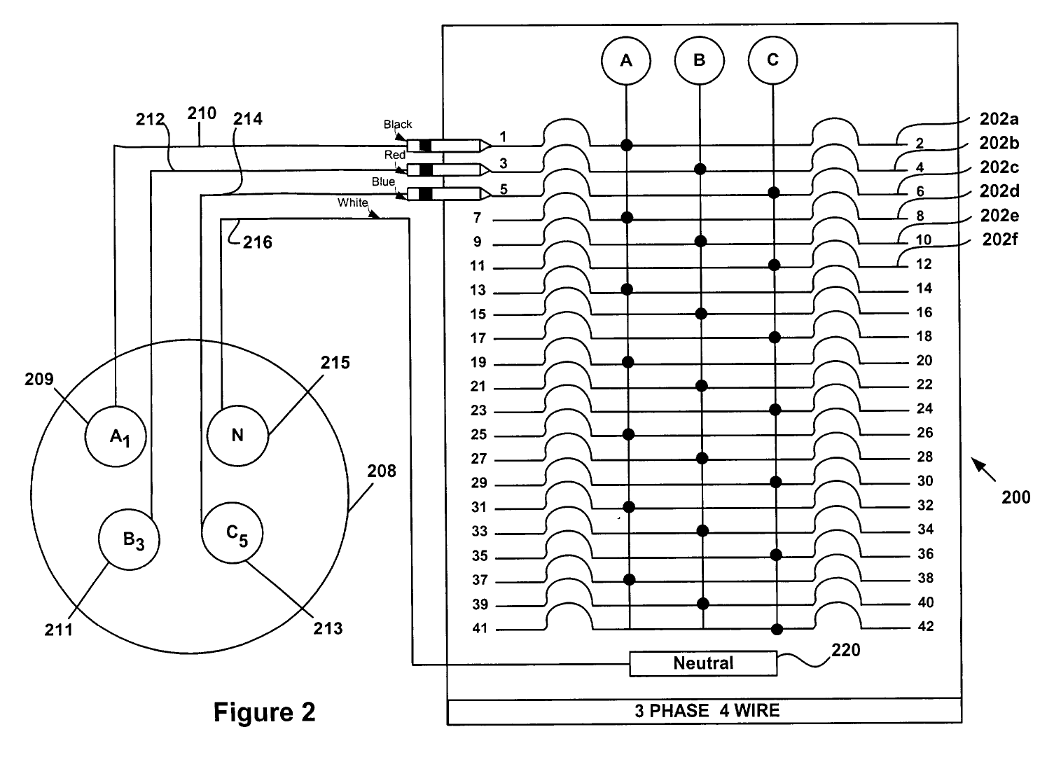

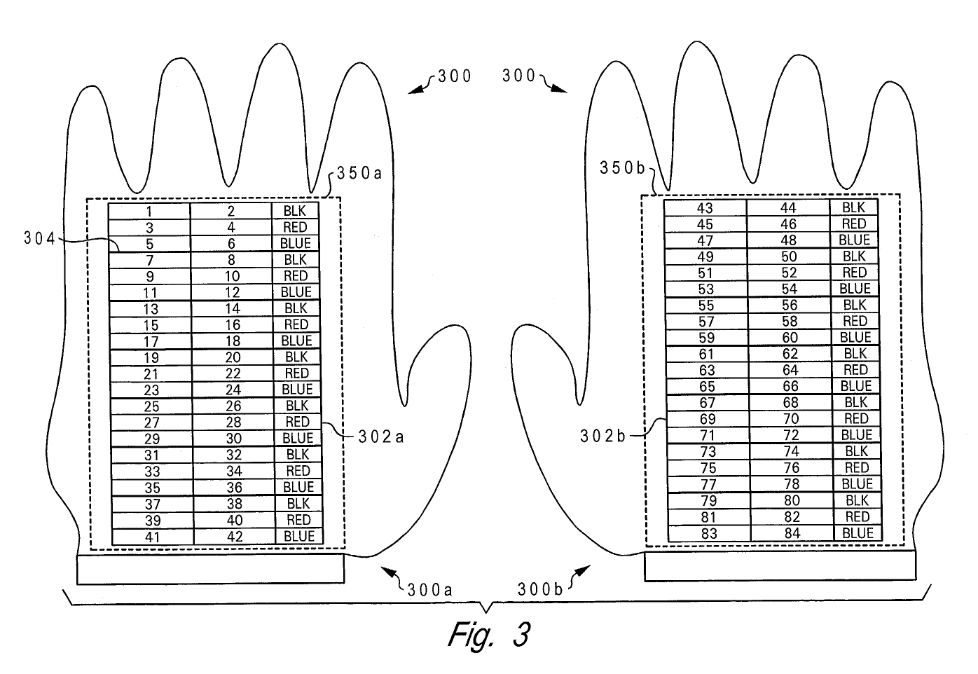

With reference now to FIG. 3, there is depicted a pair of electrician's gloves in accordance with a preferred embodiment of the present invention. As shown, a pair of electrician's glove 300 includes a left-hand glove 300a and a right-hand glove 300b. A visual guide 302a is imprinted on the back of left-hand glove 300a, and a visual guide 302b is imprinted on the back of right-hand glove 300b. Preferably, visual guides 302a-302b correspond to the layout of breaker panel 200 shown in FIG. 2. For example, the first row of visual guide 302a showing numerals “1” and “2” corresponds to the end connection points for row bus 202a of breaker panel 200. The lettering “BLK” next to the numbers “1” and “2” on the first row of visual guide 302a indicates that a black wire (power from Phase A) should be connected to either connection point “1” or connection point “2.” Likewise, the lettering “RED” next to the numbers “3” and “4” on the second row of visual guide 302a indicates that a red wire (power from Phase B) should be connected to either connection point “3” or connection point “4,” and the lettering “BLU” next to the numbers “5” and “6” on the third row of visual guide 302a indicates that a blue wire (power from Phase C) should be connected to either connection point “5” or connection point “6.” Such pattern continues for connection points 7-84, as shown in FIG. 3. Although connection point 84 is shown as the highest connection point in FIG. 3, it is understood by those skilled in the art that the highest connection point can be extended to 168.

Instead of using letters such as BLK, RED and BLU to represent Phases A, B and C, respectively, actual black, red and blue colors may also be used as an alternative representation. For example, the indicia for connection points associated with Phase A (such as connection points “1” and “2”) may be the actual color black, either in drawing the numbers themselves or as a black background or border around the numbers. The indicia for connection points associated with Phase B (such as connection points “3” and “4”) may be the actual color red, either in drawing the numbers themselves or as a red background or border around the numbers. The indicia for connection points associated with Phase C (such as connection points “5” and “6”) may be the actual color blue, either in drawing the numbers themselves or as a blue background or border around the numbers.

Each connection number represents one connection point from a group of six connection points. Each of the connection point groups is preferably divided in a multiple of six. For example, connection points 1-6 make up a first group of connection points, connection points 7-12 make up a second group of connection points, connection points 13-18 make up a third group of connection points, etc. By grouping connection points and breaking them up with a relatively thick line 304 or other visually detectable demarcation or differentiating attribute, a user of gloves 300 is able to conceptualize three-phase groupings. Thus, the three-phase power wires from equipment 208 (from FIG. 2) are connected in the same unit of connection points, allowing them to be controlled by a common or connected breaker switch (not shown).

While the indicia are preferably provided in a single two-column table format, the indicia can also be provided in a multiple two-column table format, as shown in Table I.

TABLE I

| | | | | |
|---|---|---|---|---|
| 1 | 2 | 43 | 44 | BLK |
| 3 | 4 | 45 | 46 | RED |
| 5 | 6 | 47 | 48 | BLU |
| . | . | . | . | |
| . | . | . | . | |
| . | . | . | . | |
| 37 | 38 | 79 | 80 | BLK |
| 39 | 40 | 81 | 82 | RED |
| 41 | 42 | 83 | 84 | BLU |

Connection points 1, 2, 43 and 44 are all connection points to power Phase A, and thus a black wire can be connected to any of those points. Similarly, connection points 3, 4, 45 and 46 are all connection points to power Phase B, and a red wire can be connected to any of those points, and points 5, 6, 47 and 48 are connection points for power Phase C, and a blue wire can be connected to any of those points.

In addition, guides 302a-302b are preferably printed on the back of gloves 300a-300b, respectively, in an indelible manner. Alternatively, guides 302a-302b can be printed on a laminar material, such, as paper card stock, that can be inserted into a respective one of transparent sleeves (shown as phantom lines 350a-350b) that are fastened to gloves 300a-300b.

TABLE II

| | | |
|---|---|---|
| [symbol] | [symbol] | [symbol] |
| [symbol] | [symbol] | [symbol] |
| [symbol] | [symbol] | [symbol] |
| . | . | |
| . | . | |
| . | . | |
| [symbol] | [symbol] | [symbol] |
| [symbol] | [symbol] | [symbol] |
| [symbol] | [symbol] | [symbol] |

The orientation of the connection points is preferably aligned with the orientation of the fingers on gloves 300a-300b, as shown in FIG. 3. In an alternative embodiment, the orientation of the connection points can be aligned in a 90 degree angle with the orientation of the fingers on gloves 300a-300b, as shown in Table II, such that the connection points can be conveniently read during the actual wiring process.

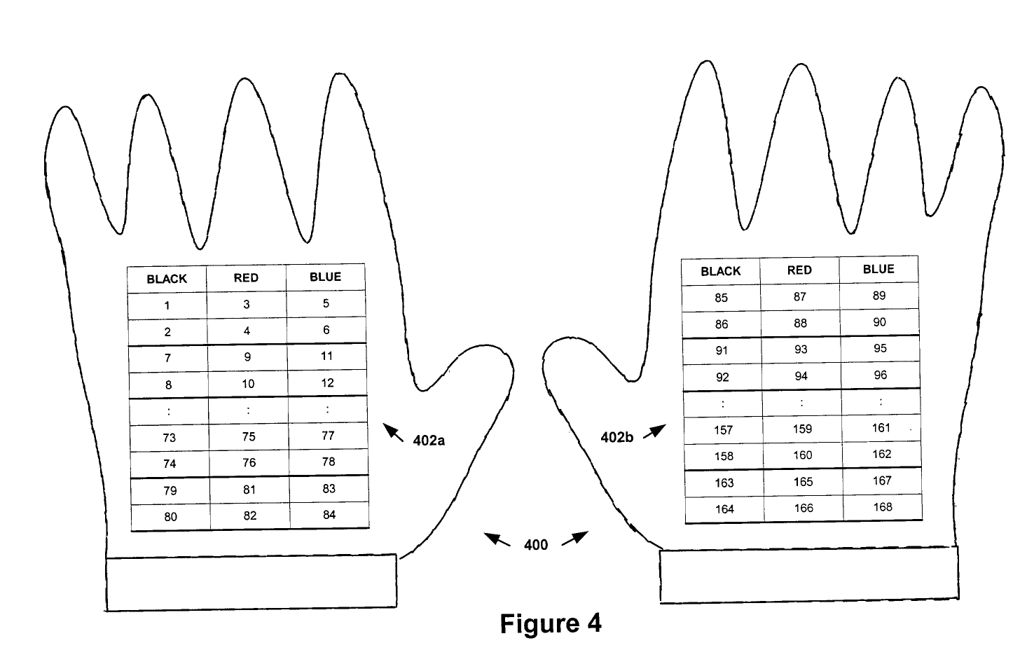

With reference now to FIG. 4, there is depicted a pair of electrician's gloves in accordance with an alternative embodiment of the present invention. In FIG. 4, the layout of guides 402a and 402b on gloves 400 does not directly correspond to the layout of the panel 200 (from FIG. 2), but rather is arranged to provide a visual cue as to which connection point is appropriate for a particular color wire. Guides 402a and 402b are preferable when the user has a specific color-coded wire, and needs to know which connection point/row bus is appropriate for use. In FIG. 4, all connection points having 11 the same phase power source are shown in a same column. That is, connection points 1, 2, 7, 8 . . . 37 and 40 are all connection points for Phase A (black wire), while 3, 4, 9, 10 . . . 38 and 41 are all connection points for Phase B (red wire) and 5, 6, 11, 12 . . . 39 and 42 are all connection points for Phase C (blue wire).

As has been described, the present invention provides a pair of electrician's gloves having a quick reference for assisting an electrician to make electrical connections to an electrical panel. Although the quick reference is provided in both gloves in the present embodiment, it is understood by those skilled in the art that the quick reference can be provided only in one of the two gloves. A Wye power connection is used in the present embodiment, it is understood by those skilled in the art that similar features as described and claimed below may also be utilized in a Delta power connection.

While the invention has been particularly shown and described with reference to a preferred embodiment, it will be understood by those skilled in the art that various changes in form and detail may be made therein without departing from the spirit and scope of the invention.

What is claimed is:

1. A glove having a visual cue for providing proper connection of a power equipment to a multi-phase electrical panel, said glove comprising:
a first set of numbers associated with a first group of connection points on said multi-phase electrical panel;
a second set of numbers associated with a second group of connection points on said multi-phase electrical panel;
a third set of numbers associated with a third group of connection points on said multi-phase electrical panel;
a first indicium associated with said first set of numbers;
a second indicium associated with said second set of numbers; and
a third indicium associated with said third group of numbers.

2. The glove of claim 1, wherein said first indicium is letters BLK, said second indicium is letters RED, and said third indicium is letters BLU.

3. The glove of claim 1, wherein said first indicium is a word “black,” said second indicium is a word “red,” and said third indicium is a word “blue.”

4. The glove of claim 1, wherein said first indicium is a color black, said second indicium is a color red, and said third indicium is a color blue.

5. The glove of claim 1, wherein said first group of numbers is defined as numbers having a remainder of either 1 or 2 when divided by a number 6, said second group of numbers is defined as numbers having a remainder of either 3 or 4 when divided by a number 6, and said third group of numbers are defined as numbers having a remainder of either 0 or 5 when divided by a number 6.
